(19) United States
(12) Patent Application Publication
(10) Pub. No.: US 2005/0138181 A1
(43) Pub. Date: Jun. 23, 2005

(54) Method for communication and/or machine resource sharing among plurality of members of a community in a communication network

(75) Inventors: Quentin Gallet, Rennes (FR); Pierre Le Lannic, Nantes (FR)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(73) Assignee: IP DIVA, Rennes (FR)

(21) Appl. No.: 10/477,732

(22) PCT Filed: May 15, 2002
(86) PCT No.: PCT/FR02/01638

(30) Foreign Application Priority Data
May 15, 2001 (FR) 01/06410

(51) Int. Cl. G06F 15/16

(52) U.S. Cl. 709/228; 709/204

(57) ABSTRACT

The invention concerns a method for communication and/or machine resource sharing, in a communication network, among a plurality of members of a community, whereby each member is considered as active or passive depending on whether he is connected or not to the community. The invention is characterised in that the method comprises a step which consists in managing, through at least one central server, a graph of connections between the active members. Said management step itself comprises a step whereby, when one of the passive members (called future active member) wishes to be connected to the community, he sets up a temporary connection with the central server, so that the latter can provide connection instructions to the future active member and to active member(s) to whom the latter has to be connected. Then, the future active member sets up a permanent peer-to-peer connection with each active member indicated by the central server. The inventive technique can be said to be hybrid peer-to-peer, since it combines centralisation of the connection graph among active members, with decentralisation of exchanges between among active members.

### FIELD OF THE INVENTION

The field of the invention is that of communication networks, particularly, but not exclusively, of the IP type (Internet networks type).

More exactly, the invention relates to the communication and/or machine resource sharing, within such a communication network, between a plurality of members of a community.

By “communication between members” is understood the possibility given to the members of a community of communicating with each other, in different modes (between two or more members, in real-time or in deferred time, etc.).

The concept of “sharing machine resources between members” covers the pooling of disk storage resources and/or computer resources for the machines available to members.

By “community” (or “tribe”), is understood a structure allowing a number of people (called “members” or “adherents”) who have at least one common centre of interest and/or one common point to be put in contact with each other. In other words, in order to form a community, users unite by affinity, by age, by place of residence, by company, etc. A community can also be a work group. Within a community, a distinction is made between on-line members (i.e. connected members), known as active (or “resident”) members, and off-line members (i.e. not connected members), known as passive members. An active member becomes a passive member (again) as soon as he is disconnected from the community. Conversely, a passive member becomes an active member (again) as soon as he is connected to the community.

Merely in the interests of simplification, in the remainder of the description, by “community member” is understood not only the natural person, but also the hardware available to that person, namely a machine (typically a microcomputer) and a piece of software (known as client software) run on this machine. The client software allows a member to be connected to at least one other active member of the community (following the example of “Internet Explorer” (trademark) software for browsing on the Web).

### PRIOR ART

Different techniques are known, in the prior art, of forming a community in the aforementioned sense, that allows its members to communicate with each other and/or to share machine resources (storage units and/or calculating units) with each other.

Three families of techniques known in the prior art will now be presented one after another. Each known technique is briefly summarised, then its drawbacks in functional and/or technological terms are disclosed.

1. Known Techniques Based on the Customer/server Model

A first family of known techniques is based on the customer/server model. The simplified hardware architecture related to this model is such that each piece of user equipment is connected to one server only. The server is furthermore connected additionally to a database.

1.1 Community Web Sites

Community Web sites are characterised by the wish to make all those using them into a genuine community. The best-known examples are “www.geocities.com”, “www.respublica.fr” and “www.multimania.fr”. They make a number of services available to users, particularly:
“chat” (short for Conversational Hypertext Access by Telecommunication) and chat rooms, for communication,
hosting “personal sites”, which are indirectly a means of exchanging content. A user can in fact use this means to pool his multimedia authoring (images, music, video etc.) or to provide links to other sites.

The drawbacks of community Web sites lie in the fact that they are a totally centralised solution. The hardware (servers) and passband costs of hosting such communities are considerable. Furthermore, the principle of exchanging files based on “uploading/downloading” (in other words uploading from a first user to the server, and downloading from the server to a second user), is inconvenient for users and does not allow exchanges in real-time.

1.2 Professional Web Sites

As an example of a professional Web site can be quoted the site “www.researcha.com”, which is the “community for information professionals”. It is a site that puts those selling and those seeking information in every field and of every nationality in contact with each other, by offering in particular to make their CV available on the site. The site moreover allows those using it to upload into the database links to sites they consider to be of interest to others, again in the information field. From a technical point of view, there is no originality in this since real exchanges, other than simple CV uploads/downloads cannot in principle occur, except via e-mail. It is, however, a good example of a virtual community of people with the same centres of interest.

Professional web sites have the same drawbacks as community web sites. It will be noted that CV uploads, downloads may be convenient since they are generally files of no great size.

1.3 Commercial Web Sites

Commercial Web sites allow their users to offer files for sale (documents, presentations, tutorials, music, video etc.). This implies that users have previously uploaded these files into the site management server. Visitors to the site can then download, in return for payment, files that interest them. As an example we may cite “ww.creavente.com”.

It is however difficult to feel that you are dealing with communities. The problem with these sites is more to do with the economic model itself. When all is said and done exchanges remain few in number and therefore the technical solution adopted poses no problem in terms of dimensioning the site.

1.4 Internet Relay Chat

Internet Relay Chat (see for example the site “www.miro.com”) is a worldwide multi-server network dedicated to “chat”. Users find themselves in rooms chatting in real-time. Internet Relay Chat uses a sophisticated version of the “Talk” protocol. There are in fact a number of “major” independent networks (more than 50,000 users simultaneously), such as “Efnet”, “Undernet”, “IRCnet” and “DALnet” (trademarks), which vary according to the length of time they have been in existence and their geographical distribution. There are additionally a certain number of smaller networks, as well as networks entirely dedicated to one topic area (children, computing, etc).

Technically speaking, communication on a chat channel is based on exchange centralisation. The path taken by a message from a chat channel member is as follows: the message is routed first to the other servers in the server network (for example “IRCnet”) that are involved in hosting the channel. Each of these then redirects the message to the other users. IRC functionalities are not restricted to just “chatting”. It allows users to exchange files using another protocol, the Client To Client Protocol (CTCP). This allows you to send a specific file to the person you are talking to, and allows you to browse in the folder being shared by the remote user and possibly to download a limited number of files from this folder.

The length of time it has been in existence and the number of people using it have made IRC into a standard. It should be noted however that the huge number of servers, which is due to the fact that genuinely “peer-to-peer” exchanges are still in the minority relative to conventional “chatting”. Furthermore there are few commercial companies hosting servers. The presence of these servers therefore depends mainly on the goodwill of the universities and other public bodies that host them. From a more functional point of view, using file exchange functionalities is very difficult for the average user.

2. Techniques Based on a Centralised “Peer-to-peer” Principle

A second family of known techniques is based on the centralised “peer-to-peer” principle. To talk about centralised “peer-to-peer” may at first sight seem a contradiction in terms. There are, however, a number of examples of sites that use this technique. The best-known example of these is unquestionably “Napster” (trademark).

2.1 Napster(www.napster.com)

Napster is a multiserver network that allows its users to exchange files in the “mp3” format. When they connect to the network, Napster users send the list of mp3 files they agree to share to a server, which stores this list on a database. This is what gives it the centralised aspect: the list of all the mp3 files, and profiles of the on-line users, are available on Napster servers. In other words, the content is shared out among the users, while the indexing of this content is centralised on the servers, in a related database. A content search is only an inquiry on this database. Once the required file is found, the two participants (users) in the “transaction” are put temporarily in contact with each other. The transfer occurring is genuinely “peer-to-peer”, in other words it does not pass through the server. As far as communication is concerned, Napster incorporates a “chat”. The structure of the Napster network is such that the servers are not connected to each other. A partition of the network into independent sub-units can therefore be witnessed.

Like all solutions requiring information to be centralised (in the present case, centralising the indexing of the content that is shared out among the users), Napster has to have a great many servers to deal with user requests. The problem arises particularly in terms of storage capacities and request management. Unlike IRCnet (see above), for example, where the servers are connected to each other, the Napster servers are independent. A user who thinks he is connecting to the Napster network is in fact only connecting to a sub-unit. This runs somewhat counter to their traditional brand position, which is founded on the concept of a world-wide community. Given its star structure, the Napster network graph finds it difficult to allow the creation of sub-communities. It is in essence mono-community. A Napster sub-network is entirely dependent on its server. It has no capacity for autonomy in the event of this breaking down. We may also quote the lack of really effective technical means to prevent files being shared that are protected by copyright.

2.2 Those “like Napster”

Napster's example has been followed by other companies, which have developed similar sites and products. This is the case of the Scour company (see “www.scour.com”), which has developed a tool, “Scour Exchange” (trademark), quite close to Napster with however the following particular difference: it allows any type of multimedia file to be exchanged, and not just mp3 files. Likewise, the company GlobalSCAPE (“www.cutemx.com/cutemx/”) has developed a tool, “CuteMX” (trademark), which is also close to Napster in its functionalities and in the techniques used. Unlike Napster and Scour, there is no restriction on the types of file exchanged. The aforementioned techniques of the Scour and GlobalSCAPE companies are very close to the one used by Napster. Their drawbacks are therefore roughly the same.

3. Known Techniques Based on a Decentralised “Peer-to-peer” Principle

A third family of known techniques is based on the decentralised “peer-to-peer” principle. Unlike the previously mentioned solutions, these do not require the use of servers, either for their maintenance or for their construction. The user must however download, from a dedicated site, a piece of client software that allows him to connect directly to the “peer-to-peer” network. In fact, through this client software, this dedicated site provides the user (newcomer) with a list of members ((without specifying whether they are active or passive, in other words on-line or off-line (i.e. connected or not) to the community)). To get connected to the community, the newcomer is invited to attempt to establish a connection with one or more users on the aforementioned list. It will be noted that the dedicated site is in no way informed of connections actually made between users, no more than it is told of any disconnections occurring between these users. Furthermore, it is of course impossible for the dedicated site to exercise any control over the content exchanged between users.

3.1 Gnutella (www.gnutella.com)

The most convincing example of this type of client software is Gnutella (trademark), which allows a network of users (in the “community” sense), the “Gnet”, to be created. The members of this network are called servents (a contraction of server and client). Four types of message can be distinguished that circulate on the Gnet (in other words which are routed via the servents): “Ping” (message transmitted by a newcomer to indicate his presence), “Pong” (response to a “Ping”, signifying “I am already on the Gnet, I am sharing N files i.e. M Kb”), “Request” (“I am looking for a file whose name contains the following character string “XXX””) and “Response” (response to a request, signifying “I have such and such a file in my possession, you can proceed to download it”). The user is then able to decide in his own time to download the file directly from the remote user who has replied to him.

The main problem with Gnutella is that it doesn't really work. The Gnet is actually overloaded. The ability of users to view the whole network is very limited. The solutions employed to overcome this may reduce these effects, but not eliminate them. The different client software that has been developed tries to integrate more sophisticated functionalities, but it is really the underlying technical principle that is ill adapted to such a large community. For the user, successfully downloading a file proves entirely random, and in any case takes a very long time. Furthermore, once in place, the “Gnet”, because it is entirely decentralised, can no longer be subject to any kind of control. The connection graph cannot therefore be optimised, so as to resolve the problems relating to the presence of residents equipped with a modem.

3.2 Freenet (ww.freenet.sourceforege.net)

Freenet is a decentralised “peer-to-peer” network, that sets out to guarantee the anonymity of its members and their freedom of expression. Freenet implements a distributed policy for managing the content it hosts. The content present on the Freenet network does not necessarily reside on the computer of the person who has introduced it; it is continually replicated from terminal to terminal. In a dynamic way, the most used or most consulted files are therefore replicated the most often. This makes it possible to guarantee the accessible nature of the files, to increase their persistence (in other words their resistance to any censoring body).

The policy for managing the content present on Freenet poses a few problems. The anonymity that protects its members does not make it into a guarantor of freedom of expression but rather a favoured vehicle for content of a pornographic nature, and for propaganda in respect of drug use. Furthermore, the man/machine interface is difficult to use.

3.3 The Mojo Nation (ww.mojonation.net)

The Mojo Nation is a “peer-to-peer” network inspired by Freenet. Its prime vocation is to resolve the problems of Gnutella and Napster with regard to the sharing of rich multimedia files, such as uncompressed videos. To this end, it allows these large size files to be split up, and the fragments obtained to be disseminated to a number of users. Downloading a file then consists in recovering the list of fragments, importing them one by one and finally reconstituting the original file. The effect of this technique is to better distribute the network load among all its members.

The act of splitting up the content requires an enormous amount of redundancy to overcome any user absence. Indeed, the loss of a fragment can render the whole file completely unusable. Furthermore, in the same way as for Freenet, the installation and use of the Mojo Nation client software are reserved for well-informed users.

### BRIEF SUMMARY OF THE INVENTION

The particular objective of the invention is to overcome these different drawbacks of the prior art.

More exactly, one of the objectives of the present invention is to provide a process for communication and/or machine resource sharing between a plurality of members of a community (in the aforementioned sense), which allows optimised management of the graph of connections between active members.

Another objective of the invention is to provide a process of this kind that allows community members to communicate with each other in real-time, and/or to share machine resources between them in real-time.

Yet another objective of the invention is to provide a process of this kind that does not require exchanges between active members to be centralised.

Another objective of the invention is to provide a process of this kind that allows both the interests of the “hosts” (also called CAP, for “community access providers”) and the interests of community members (users) to be guaranteed. For “community access providers”, the following particularly must be guaranteed: the qualification of the active members (or residents), the control of community access and the supervision of the content exchanged between community members. For community members, the interests to be guaranteed are particularly: exchange security, data security and service quality.

These different objectives, together with others which will emerge subsequently, are met according to the invention using a process for communication and/or machine resource sharing, within a communication network, between a plurality of community members, each of said members being known as an active member or passive member depending on whether he is connected or not to the community. According to the invention, said process includes a step of managing, via at least one central server, the graph of connections between active community members. This management step itself includes the following steps, when one of the passive members, known as a future active member, wishes to be connected to the community:
the future active member establishes a temporary connection with the central server, so as to inform it of his wish to connect to the community;
the central server calculates, and/or causes to be calculated, to which active member(s) the future active member is to be connected, and generates corresponding connection directives;
via said temporary connection, the central server provides connection directives to the future active member;
the central server establishes a temporary connection with each active member with whom the future active member is to be connected, in order to provide him with connection directives;
the future active member establishes a permanent connection, peer to peer, with each active member indicated to him by the central server.

The general principle of the invention therefore consists in combining centralisation of the management of the graph of connections between active members, with decentralisation of exchanges between active members (“peer-to-peer” connections between active members). The technique according to the present invention can therefore be termed “hybrid peer-to-peer”. It allows the advantages in terms of centralisation and those in terms of decentralisation to be added together, while avoiding their respective drawbacks.

In the present case, the centralised aspect allows management of the graph of connections between active community members. The connections between active community members are thus permanent (unlike the Napster solution where they are temporary) and organised intelligently (unlike the Gnutella solution, where they are totally free).

As discussed in detail in what follows, the centralised aspect also allows, possibly, community security management, control over the content of exchanges between members, the drawing up of reports (statistics for example) on the activity of active members, the authentication of passive members wishing to connect to the community, etc.

The decentralised aspect, a fundamental difference from the customer/server model, for its part allows a reduction in the load induced on the central servers, an improvement in the capacities of the communities for autonomy, the distributed storage of the community “content” (in other words files that the community members can exchange between them), operation in real-time, etc.

Preferentially, said step of managing the graph of connections between the active community members additionally includes the following steps, when one of the active members is disconnected from the community:
the central server is informed of this disconnection by the member who has again become passive and/or by at least one of the active members, and determines any active member(s) who finds himself (find themselves) detached from the community by virtue of this disconnection;
the central server calculates, and/or causes to be calculated, to which active member(s) each active member detached from the community is to be connected, and generates corresponding connection directives;
the central server establishes a temporary connection with each active member detached from the community and with each active member to whom they are to be connected, so as to provide them with connection directives;
each active member detached from the community establishes a permanent connection, peer to peer, with each active member indicated to him by the central server.

To advantage, said step of managing the graph of connections between the active community members additionally includes the following step:
at at least one moment, the central server calculates, and/or causes to be calculated, an at least partial reorganisation of the connection graph, affecting at least some active members, and generates corresponding disconnection/reconnection directives;
the central server establishes a temporary connection with each of the active members affected by the reorganisation, so as to provide them with disconnection/reconnection directives;
the active members affected by the reorganisation establish permanent connections between them, peer to peer, according to indications from the central server.

Indeed, the connection graph is the result of a succession of additions of new active members or the removal of active members who are disconnected. A partial or total reorganisation of the connection graph may therefore sometimes be necessary.

To advantage, the connection directives and/or the disconnection/reconnection directives are calculated according to at least one algorithm taking into account at least one criterion for optimising the graph of connections between active community members.

Generally speaking, it is a matter particularly of increasing the quality of service in respect of the data exchanges between active community members (while preventing bottleneck phenomena), and maintaining the connective nature of the connection graph (while preventing the appearance, within the graph, of independent sub-units).

Preferentially, said at least one connection graph optimisation criterion belongs to the group including:
reducing the redundancy of messages exchanged between active members;
cutting the time for transferring a message from one active member to another;
optimising the geographic distribution of the active members;
increasing the robustness of the structure in respect of the disconnection of one of the active members;
cutting the average number of active members to whom the active member is directly connected.

In a first advantageous embodiment of the invention, the connection directives and/or the disconnection/reconnection directives are calculated, in a centralised way, in the central server.

In a second advantageous embodiment of the invention, the connection directives and/or the disconnection/reconnection directives are calculated, in a decentralised way, by the active community members.

Preferentially, each peer-to-peer connection between two active members supports data traffic that allows at least one of the following functionalities to be delivered:
point to point message transmission;
point-multipoint broadcast message transmission;
specific content search, within disk storage resources pooled by one of the two active members;
direct exploration, within disk storage resources pooled by one of the two active members;
file downloads.

In one particular embodiment of the invention, the communication network is of the IP type. It is clear however that the present invention is not restricted to Internet networks.

Preferentially, for data transmission within the community, each active member uses a proprietary exchange protocol.

Knowledge of this proprietary exchange protocol thus has an important value, since it gives control over what can pass between active community members.

To advantage, in respect of data transmission within the community, each active member uses an exchange protocol parameterised by a key. Said step of managing the graph of connections between the active community members additionally includes the following step: at at least one moment, the central server invites each active member to modify his exchange protocol parameterisation key, in such a way that said exchange protocol is at least partially modified.

The invention thus proposes a dynamic defence, in the event of attack, through an open-ended modification of the exchange protocol between active members. It is possible to talk about a “mutant protocol”.

Preferentially, said at least one central server includes at least one connection graph management module and, possibly, at least one module delivering at least one particular functionality.

In other words, a low level architecture is developed, above which is positioned a set of modules (and components, as explained in detail hereinafter). Enhancing the central server with a new functionality amounts to adding a new module to it. It is thus possible to improve an existing module without modifying the other modules.

It should be noted that in the present description, there is a semantic distinction between a module, which is found on the central server, and a component, which is found in the client software of one of the members. Apart from this distinction, the module and the component both denote a program part that is isolatable and delivers a particular functionality.

To advantage, said at least one module delivering at least one particular functionality belongs to the group including:
modules authenticating passive members wishing to connect to the community;
modules managing community security;
modules drawing up reports about the activity of active members;
modules controlling the content exchanged between active members;
calculating unit resource sharing modules;
storage unit resource sharing modules;
text mode communication modules (chat, chatroom);
video mode (videoconferencing) communication modules;
multimedia authoring modules;
modules for games and/or interactivity between active members.

In an advantageous way, said step of managing the graph of connections between active community members additionally includes the following step: each module type is duplicated into a number of copies depending on its load, relating to the temporary connections of active members and/or of future active members.

This duplication characteristic is aimed particularly at the event of a slow variation in load. Indeed, it allows the central server to retain, for a given centralised functionality, the same quality of service to the active community members, during a slow rise in load of the module concerned by this centralised functionality. Load balancers included in the central server then allow the load to be balanced between the different modules arising out of the duplication of the initial module. Conversely, when the load is tending to drop slowly, the operation consists in deleting the modules that are not needed and/or in bringing the modules together as far as possible on the server.

In the event of a rapid increase in load, module duplication seems more difficult to conceive and it then appears difficult to retain the same quality of service in respect of the community. In terms of the member (client software), the deterioration of the service may consist in arbitrarily refusing to route certain messages that are considered to be of less importance. In terms of the central server, this deterioration occurs in an open-ended way, particularly within the connection graph management module. The latter may be led to comply less rigorously with the criteria that normally determine the graph. This allows a reduction in calculation time during connections and reorganisation. In this event, all that is left is the concern to ensure community connectivity at all costs. Generally speaking, a loss in quality in respect of the centralised functionalities is then noticeable. Conversely, in the event of a rapid drop in load, the connection graph management module naturally returns to its optimum operation.

Preferentially, each member of the community includes a piece of client software itself including:
a component for temporary connection with the central server, with a view to connecting to the community of active members;
possibly, at least one component delivering at least one particular functionality.

As for the central server modules, the components of the client software have something of the nature of the aforementioned low-level architecture specific to the invention. Enhancing the client software with a new functionality amounts to adding a new component to it.

It is possible to offer the user a range of client software, including for example a basic version that is free of charge and more advanced versions that have to be paid for.

To advantage, said at least one component delivering at least one particular functionality belongs to the group including:
calculating unit resource sharing components;
storage unit resource sharing components;
text mode communication components (chat, chatroom);
video mode (videoconferencing) communication components;
instant messaging components;
deferred message delivery components;
multimedia authoring components;
components for games and/or interactivity between active members.

It should be noted that some functionalities can be centralised (i.e. hosted by a module of the central server) and/or decentralised (i.e. hosted by a component of the client software of the community member).

In a particular embodiment of the invention, said at least one central server is pooled, so as to be able manage at least two communities.

It should be noted that one and the same user may be a member of several communities at the same time.

Preferentially, said process additionally includes a step of controlling, by the central server, the content exchanged between active members.

There is a synergy between this functionality of controlling the content exchanged and the aforementioned functionality of managing the connection graph. It will be noted that it is the centralised aspect that allows these two functionalities to be delivered.

This functionality of controlling the content exchanged allows particularly for the law on Intellectual Property (particularly respect for original work protected by Copyright) to be upheld. It is for example the community access provider who decides the exact way in which he wishes to apply the content control.

In an advantageous way, said step of controlling the content exchanged between active members includes the following steps:
at least one spy module, hosted by said at least one central server and behaving like an active member, is connected to at least one active community member;
at least one processing and/or decision module, hosted by said at least one central server, receives from said at least one spy module information relating to at least some of the data exchanged between active community members.

Through the spy module, the central server is thus indirectly itself part of the community. In other words, it can “see the community from the inside”.

To advantage, said information relating to at least some of the data exchanged between active community members belongs to the group including:
raw data exchanged between active community members;
data resulting from a pre-processing, carried out by at least one of the active members and/or said at least one spy module, of raw data exchanged between active community members.

Preferentially, said process additionally includes a step of managing the list of community members, said step of managing the graph of connections between active community members additionally includes the following step: authentication, by this central server, of the future active member wishing to be connected to the community, said authentication consisting in verifying that the future active member belongs to said list of community members.

The list of community members can be managed by the central server or by a piece of equipment remote from it (for example a specific Web site, dedicated to registering new members).

The invention also relates to a computer program including sequences of instructions adapted to implementing the process described above, when said program is run on a computer.

The invention also relates to a central server including means for managing the graph of connections between active community members, said management means themselves including the following means:
means of establishing a temporary connection with one of the passive members, known as a future active member, who wishes to inform it of his wish to be connected to the community;
calculation mans, so as to determine to which active member(s) the future active member is to be connected;
means of generating corresponding connection directives;
means of providing said connection directives, via said temporary connection, to the future active member;
means of establishing a temporary connection with each active member with whom the future active member is to be connected, so as to provide him with connection directives;
   in such a way that the future active member establishes a permanent connection, peer to peer, with the active member indicated to him by the central server.

### BRIEF DESCRIPTION OF THE SEVERAL VIEWS OF THE DRAWINGS

Other characteristics and advantages of the invention will emerge from reading the following description of a preferential embodiment of the invention, given by way of example and not restrictively, and of the appended drawings, wherein:

FIG. 1 shows the general principle of the process according to the invention, of communication and/or machine resource sharing between members of a community;

FIG. 2 shows an example of possible structure for the graph of connections between the active members of a community;

FIG. 3 shows the mechanism for controlling content in a particular embodiment of the process according to the invention;

FIG. 4 shows the positioning of an exchange protocol example used by the active members for data transmission;

FIG. 5 shows a simplified diagram of a particular embodiment of a central server according to the present invention; and

FIG. 6 shows a simplified diagram of a particular embodiment of a member of the community according to the present invention, said member being understood as the combination of the natural person user and of his machine which runs a piece of client software.

### DETAILED DESCRIPTION OF THE INVENTION

The invention therefore relates to a process for communication and/or machine resource sharing, within a communication network, between a plurality of members of a community.

In the remainder of the description, it is presupposed that the communication network is of the IP type, in other words based on the Internet protocol. It is clear that the invention is not restricted to this particular type of communication network.

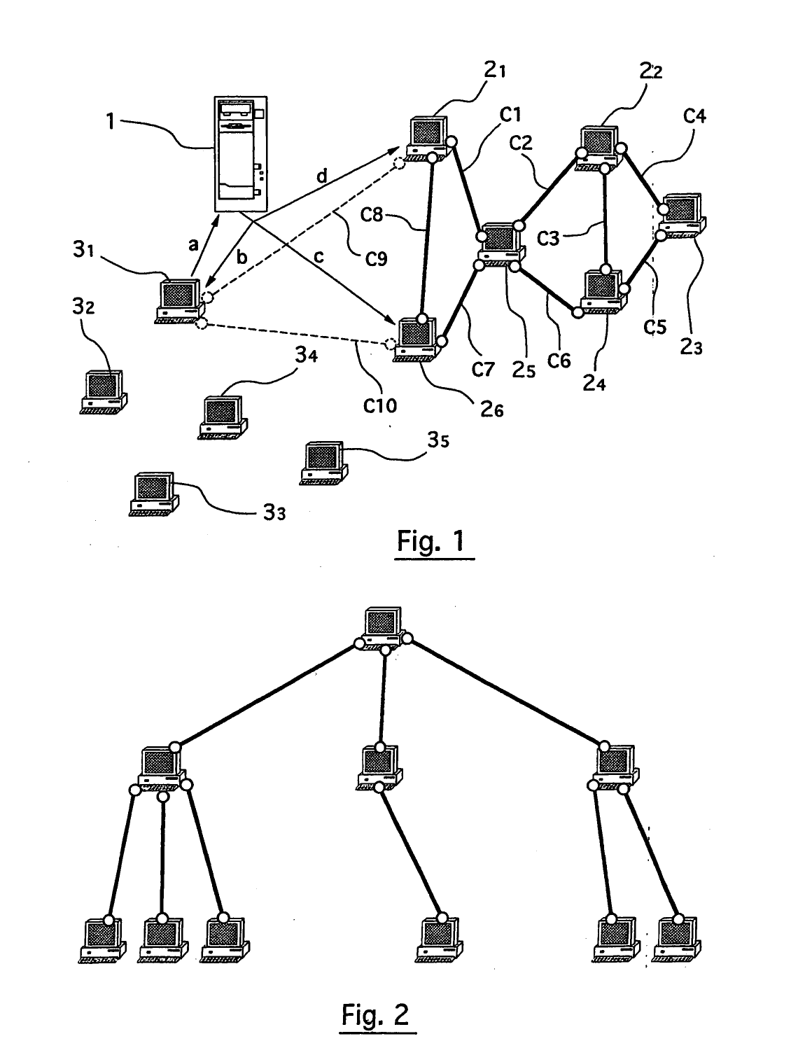

A presentation will now be given in a detailed way, in relation to FIG. 1, of the general principle of the process according to the invention, which consists in combining a centralisation of the management of the graph of connections between active members, with a decentralisation of exchanges between active members (“hybrid peer-to-peer”).

In the remainder of the description, it is pre-supposed that the aforementioned centralisation is implemented by a single central server 1. It is clear however that the invention also covers the situation where this centralisation is provided by several central servers that engage with each other.

In the interests of simplification, by “community member” 2 is understood not only the natural person 23, but also the hardware available to the latter, namely a machine 21 running a piece of client software 22 (see FIG. 6).

In the example shown in FIG. 1, it is pre-supposed that we are at a moment t when the community includes six active members 2₁ to 2₆, and passive members 3₁ to 3₅. The six active members, 2₁ to 2₆, are connected to each other via eight “peer-to-peer” (point-to-point) connections C1 to C8.

The process according to the invention offers an intelligent management of the graph of connections between the active members, when one of the passive members wishes to be connected to the community (and therefore himself to become an active member).

For example, if it is pre-supposed that the passive member given the reference 3₁ (hereinafter called the “future active member”) wishes to be connected to the community, the process according to the present invention then consists, as shown in FIG. 1, in carrying out the following steps:
the future active member 3₁ establishes a temporary connection with the central server 1, so as to inform it of his wish to be connected to the community (arrow given the reference a);
the central server 1 calculates (and/or causes to be calculated, see detailed description hereinafter of the connection graph management module) with which active members (those given the references 2₁ to 2₆, in this example) the future active member 3₁ is to be connected, and generates corresponding connection directives;
via the temporary connection, the central server 1 provides connection directives to the future active member 3₁ (arrow given the reference b);
the central server 1 establishes a temporary connection with each of the active members concerned 2₁ and 2₆, so as to provide them with the connection directives (arrows given the references c and d respectively);
the future active member 3₁, as well as each of the active members concerned 2₁ and 2₆, disconnects from the central server 1;
the future active member connects to the community by establishing a permanent “peer-to-peer” connection with each of the active members concerned 2₁ and 2₆, which the central server 1 has previously indicated to him. In FIG. 1, the two “peer-to-peer” connections thus established are shown in dotted lines and given the references C9 and C10.

Sending connection directives via the central server 1 consists in transmitting, to each member concerned via a given “peer-to-peer” connection, the IP address of the other, so that these two members can then initiate the connection.

Each “peer-to-peer” connection between two active members is permanent in the sense that it exists either until one of these two members is intentionally or accidentally disconnected, or until the connection graph is reorganised following a decision by the central server (this reorganisation is discussed in detail below).

Each “peer-to-peer” connection between two active community members may be compared to a “tunnel” supporting different data traffic depending on the functionality delivered:
point-to-point message transmission;
broadcast (or point-multipoint) message transmission;
specific content search, within disk storage resources pooled by one of the two active members;
direct exploration, within disk storage resources pooled by one of the two active members;
file downloads;
“push” function, which consists in transmitting a file to another active member (unlike downloading, where the initiative falls back on the person receiving the file);
etc.

This data is for example transmitted according to a proprietary protocol above IP. During the creation of data packets, it is necessary in this case to specify whether the transfer will occur by using the Transfer Control Protocol (TCP) or the User Datagram Protocol (UDP). FIG. 4 shows this positioning of the proprietary protocol, denoted “L2T Protocol”, at the same level as the File Transfer Protocol (FTP) and hyper text transfer protocol (http).

Data exchanges between active members can be protected by encryption (based on a conventional principle of public keys/private keys) and/or data compression (based on standard algorithms reputed for their security).

Each active member can receive and send messages. He consequently acts as a router. In practice this routing action is performed automatically, within the active member, by the machine running the client software. This therefore happens transparently in respect of the natural person user. It will be remembered that, in the interests of simplification, by “member of the community” is understood not just the natural person, but also the hardware available to the latter (machine and client software).

Two types of message in particular can be distinguished: broadcast messages and point-to-point messages. An example will now be given of managing these two types of messages through the client software of the active members.

Broadcast messages are intended for the whole community. They have a unique identifier. Each piece of client software stores in a stack the list of identifiers of the messages it has already received. This list has a size limitation: as new messages arrive, the identifiers of the oldest messages are removed.

When a piece of client software receives a broadcast message, it checks in its stack of identifiers whether it has already received it. If it has in fact already received it, it simply deletes it. In the contrary event, it sends it to all the client software to which it is connected, except obviously the one sending it. In the event of a connective structure, a distributed routing policy of this kind allows all active community members to be gradually reached. A content search is a typical example of a functionality that uses the sending of a broadcast message.

Point-to-point messages are intended for one active member in particular. A point-to-point message itself contains the exact information as to the path it has to take, knowing that this is unique. At each routing, the client software concerned merely redirects the message to the next client software, in the pre-established order of the path. Response to a request is an example of point-to-point messaging. In this event, the active member addressee is the person sending the contact search request.

The process according to the invention also offers an intelligent management of the graph of connections between the active members, when one of the active members disconnects (intentionally or not) from the community (and therefore becomes a passive member again).

The process according to the present invention then consists in carrying out the following steps:
the central server is informed of the disconnection, by the member who has become passive again and/or by at least one of the active members, and determines which possible active member (or members) finds himself (or find themselves) detached from the community as a result of this disconnection;
the central server calculates (and/or causes to be calculated) to which active members each detached active member of the community is to be connected, and generates corresponding connection directives;
the central server establishes a temporary connection with each active member detached from the community and with each active member to whom they are to be connected, so as to provide them with connection directives;
each active member detached from the community establishes a permanent “peer-to-peer” connection with each active member indicated to him by the central server.

As far as possible, this connection between two members must not occur brutally and unexpectedly. It is for this reason that mechanisms are put in place to detect and indicate as quickly as possible that this type of link is broken. These disconnection information feedback mechanisms can be implemented in the relevant active member itself (particularly if disconnection is intentional) and/or in one or more other active members.

The notion of sharing machine resources available to members will now be presented in detail.

Each active member (also called a “resident”) can decide to pool a part of his hard disk, in other words a certain number of disk storage resource units. All that is necessary for example to do this is to create on his hard disk a specific file, dedicated to sharing. He can then insert into it all the sub-files and files he is willing to share. This part of his hard disk will be available (generally in read-only, for security reasons) for other active members, either through a specific content search, or through direct exploration. The tree structures pooled by active members when taken together form the distributed community database.

In the same way, each active member can decide to pool a part of his computer's calculating capacity, in other words a certain number of calculating resource units. For the active member this amounts to making available to the community a certain percentage of his computer's CPU. It the event of it going into stand-by mode, this percentage may increase.

In FIG. 6, the disk storage resources are given the reference 211, and the part of these that is shared is represented by a hatched area and given the reference 211c. Likewise, the calculating resources are given the reference 212, and the part of these that is shared is represented by a hatched area and given the reference 212c.

This pooling of machine resources has many applications, and particularly:
decentralised Web site: the site content is hosted by the distributed community database. Web pages are generated using the calculating power of each of the computers hosting a part of the site. This implies a particular protocol and a massive redundancy of information contained in the site;
group work: computers are employed in the context of work requiring massive calculating power. This task must be decomposable into distributed sub-tasks (or example the calculation of prime numbers);
authoring tool: this authoring tool is used simultaneously by a number of active members, in the context of performing a group task.

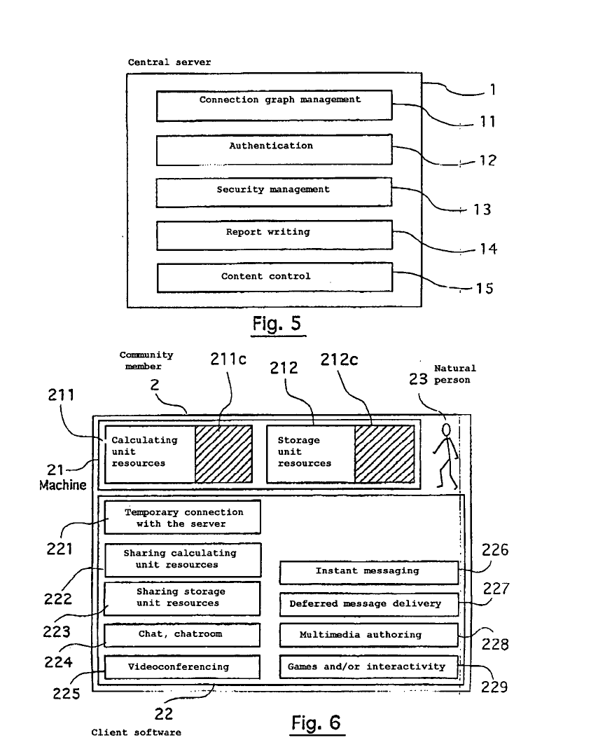

As shown above, according to the present invention, the central server 1 carries out a step of managing the graph of connections between active members. For this, as shown in FIG. 5, the central server 1 includes a connection graph management module 11.

The mission of this module 11 is particularly to:
retain a faithful image of the real community graph (this involves a concern to update and periodically save this data);
manage requests from future active members (in other words from passive members wishing to become active members). As explained in detail above, in relation to FIG. 1, this consists in receiving requests for connections from future active members, in calculating the best siting for the latter, in transmitting connection directives to them so that they can integrate de facto into the community, in transmitting these connection directives in parallel to the active members concerned;
manage disconnections, natural or sudden, of active members. As explained in detail above, this consists in adding back in to the graph the active members who have found themselves detached from the community because of disconnections;
carry out from time to time (but as infrequently as possible) a partial or complete reorganisation of the community. This may involve sending disconnection/reconnection directives to some or all of the community members.

In order to generate the connection directives and the disconnection/reconnection directives, three main calculating algorithms are employed:
a first algorithm making it possible to calculate to which active members a future active member is to be connected;
a second algorithm making it possible to calculate to which active members an active member detached from the community (because of a disconnection of another active member) is to be connected;
a third algorithm making it possible to calculate a partial or total reorganisation of the graph.

The purpose of these algorithms is to attain and to stay as close as possible to structures considered to be interesting in accordance with certain predetermined criteria. In other words, it is a matter of taking account of at least one or more graph optimisation criteria. Among these optimisation criteria may be cited:
reducing the redundancy of messages exchanged between active members;
increasing the speed of connecting active members to each other;
optimising the geographic distribution of active members;
increasing the robustness of the structure relative to the disconnection of one of the active members;
limiting the average number (a snapshot average of all active community members) of active members to whom an active member is directly connected.

It should be noted that these calculating algorithms may be executed in a centralised way, in the central server 1, and/or in a decentralised way, by the active community members. It is possible to use network simulation tools, in order to test different algorithms and to deduce which of them is the best for each of the different solutions put in place.

FIG. 2 shows an example of a possible structure for the graph of connections between active members of a community. This spanning tree structure has the celebrated advantage of eliminating message redundancy. If moreover the tree is balanced, this allows the maximum time for transferring a message from one user to another to be cut.

A presentation will now be given, in relation to FIG. 5, of a particular embodiment of the central server 1 according to the present invention. In this embodiment, the central server 1 includes, apart from the aforementioned connection graph management module 11:
a module 12 authenticating passive members wishing to be connected to the community;
a module 13 managing community security;
a module 14 establishing reports (statistics) on the activity of active members;
a module 15 controlling the content exchanged between active members.

The role of the authentication module 12 is to verify that the passive member sending a connection request is in fact part of the community. Authentication consists for example in verifying a login identifier and a password provided by this member. This presupposes management, internal or external to the central server 1, of the list of community members.

The security management module 13 uses conventional firewall methods for example, and also mechanisms for verifying the validity of requests coming from members. It can also provide controlled mutation of the data exchange protocol between active members. In this event, each active member uses an exchange protocol parameterised by a key. When it deems it necessary, the central server invites each active member to modify his exchange protocol parameterisation key. This security mechanism can be summarised as follows: each piece of client software has at any given moment a special key. This special key is encoded and concealed in such a way as to be out of reach of the end user. Its function is to condition the way in which data packets are created and transmitted. Periodically and/or whenever a threat is felt, the central server causes the special keys of the client software to “mutate”. This helps to modify particularly the exchange protocol in respect of the community. The advantage of this technique is that it makes it very difficult to apply any back engineering to the protocol.

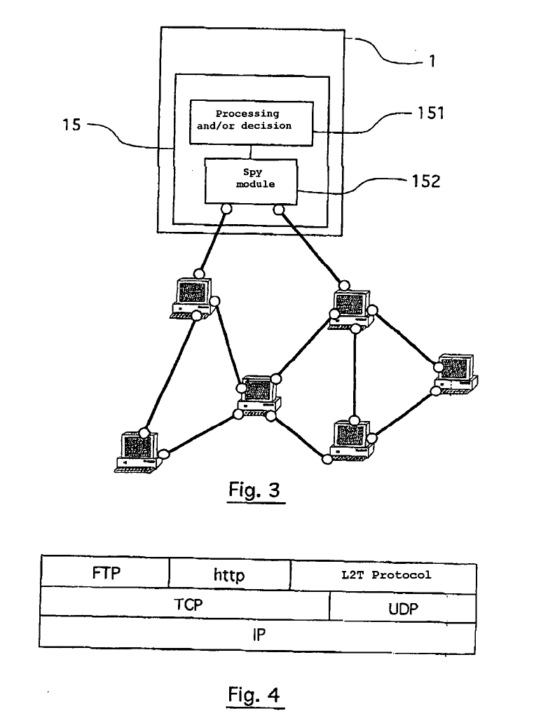

A presentation will now be given, in relation to FIG. 3, of a particular embodiment of the module 15 for controlling the content exchanged between active members. In this particular embodiment, the aforementioned module 15 itself includes a spy module 151 and a processing and/or decision module 152. The spy module 151 behaves like an active member and is connected to at least one (real) active member of the community. The processing and/or decision module 152 receives from the spy module 151 information relating to at least some of the data exchanged between active community members. In the light of this information, and after any processing applied to them, the aforementioned module 152 decides whether the content exchanged is acceptable or not. Active members are said to be concerned by a content that is considered unacceptable if, for example, they transmit requests or share files containing elements that are licentious, Nazi in character, protected by Copyright, etc. These active members may be banned from the community, or denounced to the legal authorities in the most serious cases.

Several types of information are conceivable, fed back by the spy module and 151 and relating to at least some of the raw data exchanged between active members:
either the spy module 151 just feeds back the raw data itself to the processing and/or decision module 152. In this event this raw data is processed in the processing and/or decision module 152;
or the spy module 151 itself pre-processes the raw data (in order to detect unacceptable content), and feeds back pre-processed data to the processing and/or decision module 152.

According to yet another variant, it is some or all of the active members (and more exactly their client software) who pre-process the raw data, and the pre-processed data is fed back to the spy module 151, which itself feeds it back to the processing and/or decision module 152.

A presentation will now be given, in relation to FIG. 6, of a particular embodiment of a community member according to the present invention. It will be remembered that in the interests of simplification, by member 2 is understood the combination of the natural person user 23 and his machine 21 which runs a piece of client software 22.

In this embodiment, the client software 22 includes:
a component 221 for temporary connection with the central server 1, with a view to connecting to the community of active members (see explanations above);
a calculating unit resource sharing component 222 (see explanations above);
a storage unit resource sharing component 223 (see explanations above);
a text mode (chat, chatroom) communication component 224;
a video mode (videoconferencing) communication component 225;
an instant messaging component 226;
a deferred message delivery component 227;
a multimedia authoring component 228;
a component 229 for games and/or interactivity between active members.

It is clear that many other embodiments of the invention are conceivable. Generally speaking, the present invention has many applications, such as particularly:
sharing information within a user group;
sharing calculating power;
synchronising content between several storage areas;
decentralising expensive services (“chat”, chatroom, Internet site or multimedia content hosting, etc);
increasing interactivity between users, between customers and suppliers;
improving the qualification and customer loyalty of the Internet site audience;
bringing the real-time dimension into the use of Internet applications (where the, e-mail, FFP, etc.);
setting up additional rapidly deployed and inexpensive services on intranet type solutions;
etc.

1. Process for communication and/or machine resource sharing, within a communication network, between a plurality of members of a community, each of the members being an active member or passive member depending on whether it is connected or not to the community, characterized in that the process includes a step of managing, via at least one central server, the graph of connections between the active community members, the management step itself including the following steps, when one of the passive members wishes to be connected to the community as a future active member:
the future active member establishes a temporary connection with the central server, so as to inform the central server of its wish to connect to the community;
the central server calculates, and/or causes to be calculated, to which active member(s) the future active member is to be connected, and generates corresponding connection directives;
via the temporary connection, the central server provides connection directives to the future active member;
the central server establishes a temporary connection with each active member with whom the future active member is to be connected, in order to provide it with connection directives;
the future active member establishes a permanent connection, peer to peer, with each active member indicated to it by the central server.

2. Process according to claim 1, characterized in that the step of managing the graph of connections between active community members additionally includes the following steps, when one of the active members is disconnected from the community:
the central server is informed of this disconnection, by the member who has become passive and/or by at least one of the active members, and determines any active member(s) who finds itself (find themselves) detached from the community by virtue of this disconnection;
the central server calculates, and/or causes to be calculated, to which active member(s) each active member detached from the community is to be connected, and generates corresponding connection directives;
the central server establishes a temporary connection with each active member detached from the community and with each active member to whom they are to be connected, so as to provide them with connection directives;
each active member detached from the community establishes a permanent connection, peer to peer, with each active member indicated to it by the central server.

3. Process according to claim 1, characterized in that the step of managing the graph of connections between active community members additionally includes the following step:
at at least one moment, the central server calculates, and/or causes to be calculated, an at least partial reorganization of the connection graph, affecting at least some active members, and generates corresponding disconnection/reconnection directives;
the central server establishes a temporary connection with each of the active members affected by the reorganization, so as to provide them with disconnection/reconnection directives;
the active members affected by the reorganization establish permanent connections between them, peer to peer, according to indications from the central server.

4. Process according to claim 1, characterized in that the connection directives and/or the disconnection/reconnection directives are calculated according to at least one algorithm taking into account at least one criterion for optimizing the graph of connections between active community members.

5. Process according to claim 4, characterized in that the at least one connection graph optimization criterion belongs to the group including:
reducing the redundancy of messages exchanged between active members;
cutting the time for transferring a message from one active member to another;
optitimizing the geographic distribution of the active members;
increasing the robustness of the structure in respect of the disconnection of one of the active members;
cutting the average number of active members to whom the active member is directly connected.

6. Process according to claim 1, characterized in that the connection directives and/or the disconnection/reconnection directives are calculated, in a centralized way, in the central server.

7. Process according to claim 1, characterized in that the connection directives and/or the disconnection/reconnection directives are calculated, in a decentralized way, by the active community members.

8. Process according to claim 1, characterized in that each peer-to-peer connection between two active members supports data traffic that allows at least one of the following functionalities to be delivered:
point to point message transmission;
point-multipoint broadcast message transmission;
specific content search, within disk storage resources pooled by one of the two active members;
direct exploration, within disk storage resources pooled by one of the two active members;
file downloads.

9. Process according to claim 1, characterized in that the communication network is of the IP type.

10. Process according to claim 1, characterized in that, for data transmission within the community, each active member uses a proprietary exchange protocol.

11. Process according to claim 1, characterized in that, for data transmission within the community, each active member uses an exchange protocol parameterized by a key, and in that the step of managing the graph of connections between active community members additionally includes the following step:
at at least one moment, the central server invites each active member to modify his exchange protocol parameterization key, in such a way that the exchange protocol is at least partially modified.

12. Process according to claim 1, characterized in that the at least one central server includes:
at least one connection graph management module;
possibly, at least one module delivering at least one particular functionality.

13. Process according to claim 12, characterized in that the at least one module delivering at least one particular functionality belongs to the group including:
modules authenticating passive members wishing to connect to the community;
modules managing community security;
modules drawing up reports about the activity of active members;
modules controlling the content exchanged between active members;
calculating unit resource sharing modules;
storage unit resource sharing modules;
text mode communication modules (chat, chatroom);
video mode (videoconferencing) communication modules;
multimedia authoring modules;
modules for games and/or interactivity between active members.

14. Process according to claim 12, characterized in that the step of managing the graph of connections between active community members additionally includes the following step:
each module type is duplicated into a number of copies depending on its load, relating to the temporary connections of active members and/or of future active members.

15. Process according to claim 1, characterized in that each community member includes a piece of client software itself including:
a component for temporary connection with the central server, with a view to connecting to the community of active members;
possibly, at least one component delivering at least one particular functionality.

16. Process according to claim 15, characterized in that the at least one component delivering at least one particular functionality belongs to the group including:
calculating unit resource sharing components;
storage unit resource sharing components;
text mode communication components (chat, chatroom);
video mode (videoconferencing) communication components;
instant messaging components;
deferred message delivery components;
multimedia authoring components;
components for games and/or interactivity between active members.

17. Process according to claim 1, characterized in that the at least one central server is pooled, so as to be able to manage at least two communities.

18. Process according to claim 1, characterized in that it additionally includes a step of controlling, via the central server, the content exchanged between active members.

19. Process according to claim 18, characterized in that the step of controlling the content exchanged between active members includes the following steps:
at least one spy module, hosted by the at least one central server and behaving like an active member, is connected to at least one active community member;
at least one processing and/or decision module, hosted by the at least one central server, receives from the at least one spy module information relating to at least some of the data exchanged between active community members.

20. Process according to claim 19, characterized in that the information relating to at least some of the data exchanged between active community members belongs to the group including:
raw data exchanged between active community members;
data resulting from a pre-processing, carried out by at least one of the active members and/or the at least one spy module, of raw data exchanged between active community members.

21. Process according to claim 1, characterized in that it additionally includes a step of managing the list of community members, and in that the step of managing the graph of connections between active community members additionally includes the following step:
authentication, by the central server, of the future active member wishing to be connected to the community, the authentication consisting in verifying that the future active member belongs to the list of community members.

22. Computer program, characterized in that it includes sequences of instructions adapted to implementing a process according to claim 1 when the program is run on a computer.

23. Central server of a system for communication and/or machine resource sharing, within a communication network, between a plurality of members of a community, each of the members being an active member or passive member depending on whether it is connected or not to the community,
characterized in that the central server includes means of managing the graph of connections between active community members, the management means themselves including the following means:
means of establishing a temporary connection with one of the passive members who wishes to inform the central server of its wish to be connected to the community as a future active member;
calculation means, so as to determine to which active member(s) the future active member is to be connected;
means of generating corresponding connection directives;
means of providing the connection directives, via the temporary connection, to the future active member;
means of establishing a temporary connection with each active member with whom the future active member is to be connected, so as to provide it with connection directives;
in such a way that the future active member establishes a permanent connection, peer to peer, with the active member indicated to it by the central server.
